(19) United States
(12) Patent Application Publication
(10) Pub. No.: US 2026/0079512 A1
(43) Pub. Date: Mar. 19, 2026

(54) Circuit Arrangement For Voltage-Controlled Power Supply Of An Electrical Consumer In A Vehicle, And Use Of Such A Circuit Arrangement

(71) Applicant: Schaeffler Technologies AG & Co. KG, Herzogenaurach (DE)

(72) Inventors: Alfons Fisch, Falkenstein (DE); Fausto Alberto Garcia Gaitan, Guadalajara (MX)

(73) Assignee: Schaeffler Technologies AG & Co. KG, Herzogenaurach (DE)

(21) Appl. No.: 19/398,337

(22) Filed: Nov. 24, 2025

Related U.S. Application Data
(63) Continuation of application No. PCT/EP2024/063931, filed on May 21, 2024.

(30) Foreign Application Priority Data
May 24, 2023 (DE) 10 2023 204 834.5

(51) Int. Cl. G05F 1/569; B60L 3/12; G05F 1/575; H02H 3/20

(52) U.S. Cl. CPC G05F 1/569; B60L 3/12; G05F 1/575; H02H 3/202

(57) ABSTRACT

A circuit arrangement for supplying power to an electrical consumer in a vehicle is provided. The circuit arrangement includes a voltage regulator component having an input terminal for inputting an input voltage, an output terminal for outputting an output voltage to the consumer, and a feedback terminal for inputting a feedback voltage that uses the voltage regulator component for regulating the output voltage. The circuit arrangement also includes an output line running from the output terminal to the consumer, and a feedback circuit connected to a circuit node of the output line and to the feedback terminal. To protect the output connection from a short-circuit-induced overvoltage, a semiconductor component arranged in a portion of the output line between the output terminal and the circuit node is provided.

### CROSS-REFERENCE TO RELATED APPLICATIONS

This application claims the benefit of PCT Application PCT/EP2024/063931, filed May 21, 2024 which claims priority to German Application DE 10 2023 204 834.5, filed May 24, 2023. The disclosures of the above applications are incorporated herein by reference.

### TECHNICAL FIELD

The disclosure relates to a circuit arrangement and to the use of the circuit arrangement.

### BACKGROUND

The generic circuit arrangement for supplying power to an electrical consumer includes a voltage regulator component having an input terminal for inputting an input voltage, an output terminal for outputting an output voltage to the electrical consumer, and a feedback terminal for inputting a feedback voltage that is dependent on the output voltage and that the voltage regulator component uses as a variable for regulating the output voltage.

Furthermore, the circuit arrangement includes an output line running from the output terminal of the voltage regulator component to the electrical consumer and a feedback circuit connected to a circuit node of the output line and to the feedback terminal of the voltage regulator component, which feedback circuit is used to generate the feedback voltage from the output voltage tapped at the circuit node and to feed the generated feedback voltage to the feedback terminal.

The mentioned voltages are to be understood here as referring to a common reference potential, which is also subsequently referred to as ground potential.

Such circuit arrangements and voltage regulator components that can be used for this purpose are known from the prior art and can advantageously be used, for example, to supply power to electrical consumers in a vehicle, which consumers require a well-defined and particularly stable supply voltage. This is the case, for example, for many control unit components such as microcontrollers and sensor devices in vehicles.

Known voltage regulator components typically include: a controllable forward element (for example transistor) in a current path running from the input terminal to the output terminal, an internal reference voltage source for providing a reference voltage, or an input terminal (setting terminal) for inputting such a reference voltage from an external source, and a fault amplifier (regulating amplifier) for amplifying a difference between the feedback voltage input at the feedback terminal and the reference voltage.

The forward element is controlled by an output signal from the fault amplifier in such a way that the feedback voltage is matched to the reference voltage. If the feedback voltage is lower than the reference voltage, the fault amplifier is used to increase the current flow through the forward element, which also increases the output voltage. However, if the feedback voltage is higher than the reference voltage, this current flow and consequently the output voltage is reduced.

In the simplest case, the “feedback circuit” includes an electrical connection between the circuit node (branch) of the output line and the feedback terminal. In this case, the output voltage itself is used as a variable for regulating the output voltage and the output voltage is regulated to the reference voltage. The electrical connection may, in this case, have a low impedance, or else may have a significant resistance, in order to protect the feedback input through the current-limiting effect of the resistor in the event of an excessively high voltage arising in the region of the output line.

As an alternative, the feedback circuit may be, for example, a voltage divider (for example a series circuit made of two ohmic resistors) connected to the circuit node in order to thus generate a voltage-divided version of the output voltage and feed it to the feedback terminal. In this case, the output voltage is regulated to a multiple of the reference voltage defined by the voltage divider.

When using the circuit arrangement for supplying an electrical consumer in a vehicle, the output line runs starting from the output terminal of the voltage regulator component, which may be installed, for example, in an electronic control unit of the vehicle, usually over a considerable length (for example several meters) up to the electrical consumer, the line typically being routed in a so-called cable harness (together with other lines) and/or via electrical connection devices such as plug connectors, etc.

Particularly in such installation environments, there is a risk that the voltage regulator component will be damaged or even destroyed by a short circuit of the output line, whether it be with respect to a reference potential (ground potential) or a supply voltage (for example battery voltage) of an electrical on-board power supply system of the vehicle, for example. In order to withstand such fault-related voltage loads, commercially available voltage regulator components usually have a certain dielectric strength of the output terminal.

However, it has been found that, in certain usage situations, the protective measures constructively implemented in common voltage regulator components and in this case, in particular, the dielectric strength of the output terminal may not be sufficient in some circumstances to sufficiently protect the voltage regulator component in the event of an excessively high voltage arising in a portion of the output line (for example due to a short circuit with respect to a relatively high on-board power supply system supply voltage). In other words, in the prior art, there is the problem that the range of use of the circuit arrangement is more or less restricted depending on the dielectric strength of the voltage regulator component used.

### SUMMARY

The disclosure provides a circuit arrangement that eliminates the above problem and thus extends the range of use of a circuit arrangement of the type mentioned at the beginning.

In some implementations, the circuit arrangement includes a semiconductor component arranged in a portion of the output line between the output terminal and the circuit node, which semiconductor component comes to have a high impedance in the event of an excessively high voltage arising in a portion of the output line between the semiconductor component and the electrical consumer in order to prevent an excessive voltage increase at the output terminal. The above-mentioned “high voltage” or the “voltage increase” are to be understood here, again, like the other voltages, in relation to a relevant reference potential, which is also subsequently referred to as ground potential.

In some examples, the method prevents the voltage regulator component being damaged by an excessively high voltage in the region of the output line, which increases the range of use of the circuit arrangement.

An excessively high voltage in the region of the output line is in principle already present when this voltage is significantly greater (for example by more than 10%) than the “setpoint value” of the output voltage, to the value of which it is regulated by way of the voltage regulator component. In practice, however, it is important that the disclosure can be used, depending on the specific design, for example to achieve protection against an excessively high voltage that is much larger (for example at least twice as large) than this setpoint. An excessively high voltage in the region of the output line is therefore present, such as if it exceeds a predefined setpoint value of the output voltage by more than 10% or by more than 100%.

In some implementations, provision is made, for example, for an excessive voltage increase (that damages the voltage regulator component) at the output terminal to still be prevented even in the event of the voltage in the region of the output line assuming a value of more than 4 times, for example more than 8 times, the setpoint value of the output voltage. The value of the excessively high voltage up to which the circuit arrangement remains functional (that is to say is not damaged or destroyed) is also referred to below as the “maximum design voltage”.

In some examples, in some uses (in a vehicle), the selection of a maximum design voltage in the range of 8 times to 15 times and/or in the range of at least 50 V (such as at least 60 V) to 100 V is advantageous.

In some implementations, provision is made,, assuming the semiconductor component is operating correctly, for the voltage prevailing at the output terminal to always remain below 2 times, such as below 1.5 times, the setpoint voltage (output voltage) prevailing there in normal operation.

The feature according to which the semiconductor component “comes to have a high impedance” in the case of a fault (an excessively high voltage) in the region of the output line can be implemented in different ways (see also exemplary embodiments). It is essential in this case that the electrical properties of the semiconductor component (such as can be represented by at least one “characteristic curve”) in conjunction with the integration thereof into the circuit arrangement result in the fact that, in the event of a fault, the resistance of the semiconductor component increases considerably from a certain value of the excessively high voltage.

In some implementations, the output voltage (setpoint value of the output voltage to which it is regulated) is in a range of from 3 V to 6 V, for example at about 5 V. Many electronic devices require a stable supply voltage in this range.

In some examples, the input voltage is in the range of from 5 V to 12 V, for example at about 6 V.

In some implementations, the difference between the input voltage and the output voltage is in a range of from 0.5 V to 5 V, for example about 1 V. Most of the voltage regulator components to be used within the scope of the disclosure require a certain minimum value of this voltage difference due to design reasons, also referred to as the dropout voltage of the voltage regulator component in question, and is typically in the range of from approximately 0.5 V to 1.5 V.

In some examples, the current carrying capacity of the output terminal, that is to say the maximum available current strength at the setpoint value of the output voltage, is in a range of from 1 mA to 300 mA, for example at about 30 mA.

In some implementations, provision is made for the electrical consumer to be a sensor device of a vehicle to be supplied with the output voltage.

The sensor device may include in this case one or more sensors, for example a sensor for measuring a pressure or a temperature. As an alternative or in addition, the sensor device may include, for example, a sensor for measuring a position, for example an angle of rotation, of a mechanical component. By using the disclosure, such sensor devices may advantageously be supplied with a stable supply voltage, with the inherently increased risk of short circuits in a vehicle advantageously being taken into account at the same time.

In some examples, at least portions of the output line run in a cable harness of a vehicle. Such a cable harness is a possibly branched strand formed from a plurality of cables for transmitting electrical information signals (for example data signals) and/or electrical currents (for the transmission of energy). Electrical connection devices such as plug connectors etc. often also form a constituent of the cable harness, in which the cables in question are usually held together by mechanical means such as cable ties and/or encasing tubes. The use of the disclosure is advantageous in such an installation environment due to the increased risk of short circuits.

In some implementations, the electrical consumer is provided in a vehicle, where an electrical on-board power supply system of the vehicle has an on-board power supply system voltage of more than 12 V. In some examples, an advantageous use of the disclosure results for an on-board power supply system voltage (for example battery voltage) of the vehicle of more than 20 V, for example 24 V, as is common for many types of commercial vehicles is provided.

In some implementations, the output line has a length of more than 1 m, such as more than 2 m. An advantageous use of the disclosure results for a length of the output line of more than 5 m, such as in the case of a supply of a sensor device of a vehicle, and here again is not uncommon, for example, especially in a commercial vehicle. A maximum length of the output line may be limited to 20 m or 50 m or 100 m.

In this context, it has been found that a relatively long length of the output line or, more precisely, the associated greater parasitic inductance of the output line can aggravate the problem on which the disclosure is based by way of an effect that can be explained as follows: The inductance of the output line, together with a capacitance, which is often arranged in practice, for example, at the output terminal of the voltage regulator component and/or at an input of the electrical consumer (for example capacitor for buffer-storing the supply voltage), forms a resonant circuit with very low attenuation. This resonant circuit may be triggered to oscillate by way of a sudden short circuit arising on the output line with respect to a certain voltage, such as an on-board power supply system voltage (for example battery voltage) in a vehicle, where, due to an initial overshoot process, a voltage even appreciably exceeding the voltage concerned (for example on-board power supply system voltage) may temporarily affect the output terminal of the voltage regulator component. In this respect, the use of the disclosure is particularly advantageous in the case of longer lengths of the output line and/or relatively large on-board power supply system voltages, in order to prevent damage to the voltage regulator component.

The disclosure may also advantageously be used in this case, for example, if a capacitor arranged between the output line and ground potential (for example for the purpose of buffer-storing the output voltage) has a relatively small (internal) loss resistance, for example less than 100 mΩ, such as less than 50 mΩ) because in this case the aforementioned resonant circuit has low attenuation. In some implementations, a ceramic capacitor or, for example, a film capacitor can therefore be provided at this point without any problems (for example with a loss resistance (in series with the capacitance) of less than 50 mΩ).

In some implementations, the feedback circuit includes a current limiting resistor arranged between the circuit node and the feedback terminal and a Zener diode arranged between the feedback terminal and a ground potential (the breakdown voltage of which is greater than the setpoint value of the output voltage).

In this case, if the value of the current limiting resistance is significantly smaller than the blocking resistance of the Zener diode (or negligible in comparison to the latter), then in normal operation practically the entire output voltage is fed to the feedback terminal as a variable and consequently the voltage regulator component regulates the output voltage to the reference voltage.

As an alternative to a Zener diode, other diodes designed for operation in the reverse direction in the range of a breakdown voltage are also considered, such as a suppressor diode, etc. Furthermore, a varistor can also be used at this point.

In some examples, in comparison to the feedback circuit mentioned further above consisting only of an electrical connection or a current limiting resistor between the circuit node and the feedback terminal is that, in the event of an excessively high voltage arising in the region of the output line, the component in question, for example a Zener diode, due to its breakdown, relieves the load on the feedback input and optionally also the semiconductor component provided in the disclosure.

In this respect, in some examples, provision is made for the diode in question to be selected with a breakdown voltage that, on the one hand, is at least 10% greater than the setpoint value of the output voltage and, on the other hand, is, for example, in the range of 0.15 times to 0.5 times the above-mentioned design maximum voltage of the circuit arrangement.

In some examples, the semiconductor component is a diode (polarized in the forward direction for the current flowing to supply the electrical consumer). If an excessively high voltage arises in a portion of the output line between the diode and the electrical consumer, the polarity of the voltage prevailing at the diode changes, so that the diode comes to have a high impedance (in the reverse direction) and thus an excessive voltage increase at the output terminal is prevented.

The “high impedance” required within the scope of the disclosure in the event of the excessively high voltage arising can be considered as given in this example (semiconductor component=diode), for example, if a leakage current of the element (in the event of a fault) is lower than the forward current (in normal operation) of the element by at least a factor of 100, in particular at least a factor of 500.

However, the problem in both examples with the diode is the voltage drop of typically about 0.5 V to 0.7 V resulting at the diode in normal operation of the circuit arrangement, which, on the one hand, disadvantageously entails a relatively high power dissipation and, on the other hand, restricts the freedom in selecting the input voltage at the voltage regulator component insofar as the voltage regulator components discussed here require a certain minimum value of the difference between the input voltage and the output voltage (dropout voltage) in order to achieve fault-free regulation of the output voltage. For example, with a dropout voltage of the voltage regulator component used of, for example, 0.5 V and a desired output voltage of 5 V, the above-mentioned use of a diode with a voltage drop of 0.7 V at the output terminal would make it impossible to provide an input voltage of 6 V. In this example, a minimum of 6.2 V would be necessary.

In some examples, the semiconductor component is a transistor, such as a field-effect transistor (FET). Thus, the voltage drop resulting at the semiconductor component (transistor) in normal operation may advantageously be much smaller than in the case of a diode.

In some implementations, a control terminal of the transistor, that is to say base terminal in the case of a bipolar transistor or gate terminal in the case of a FET, is actuated by a voltage (for example switching voltage for switching the transistor) generated by way of an actuation device of the circuit arrangement as a function of the voltage prevailing at the circuit node in such a way that the transistor is brought to a reverse state and therefore comes to have a high impedance when an excessively high voltage arises at the circuit node.

The actuation device may for this purpose have, for example, a comparator for comparing the voltage prevailing at the circuit node or a (for example voltage-divided) voltage derived therefrom, on the one hand, with a fixedly predefined voltage, on the other hand, to actuate the transistor by means of an output signal of the comparator.

In some implementations, a fixedly predefined voltage is applied to a control terminal of the transistor, which voltage is selected such that the transistor is brought into a reverse state and thus comes to have a high impedance when an excessively high voltage arises at the circuit node.

In some examples, the fixedly predefined voltage is a supply voltage provided anyway for supplying the voltage regulator component and/or other electronic components. For example, this supply voltage may be a 12 V voltage, as is often used in vehicles, for example, as an auxiliary voltage for actuating power output stages (for example inverters for energizing electric drives).

Such other electronic components may, for example, be components arranged together with the voltage regulator component in an electronic control unit of a vehicle.

As an alternative or in addition, it may also advantageously be an on-board power supply system voltage provided by an electrical on-board power supply system of a vehicle. This applies if this on-board power supply system voltage is provided in any case in the region of the installation location of the voltage regulator component (for example in an electronic control unit) and/or on a line of a cable harness, which is also provided for routing the output line.

Another aspect of the disclosure provides the use of a circuit arrangement of the type described here for supplying power to an electronic component in a vehicle, where the component may be a sensor device, for example.

In some examples, the sensor device may be arranged in the vehicle at a distance from a control unit that supplies the sensor device and contains the voltage regulator component.

The implementations described here for the circuit arrangement according to the disclosure and particular configurations can also be analogously provided individually or in any desired combination as examples or particular configurations of the use according to the invention, and vice versa.

### DESCRIPTION OF DRAWINGS

FIG. 1 shows a circuit arrangement according to the prior art,

FIG. 2 shows a circuit arrangement according to a first exemplary implementation,

FIG. 3 shows a circuit arrangement according to a second exemplary implementation, and

FIG. 4 shows a circuit arrangement according to a third exemplary implementation.

Like reference symbols in the various drawings indicate like elements.

### DETAILED DESCRIPTION

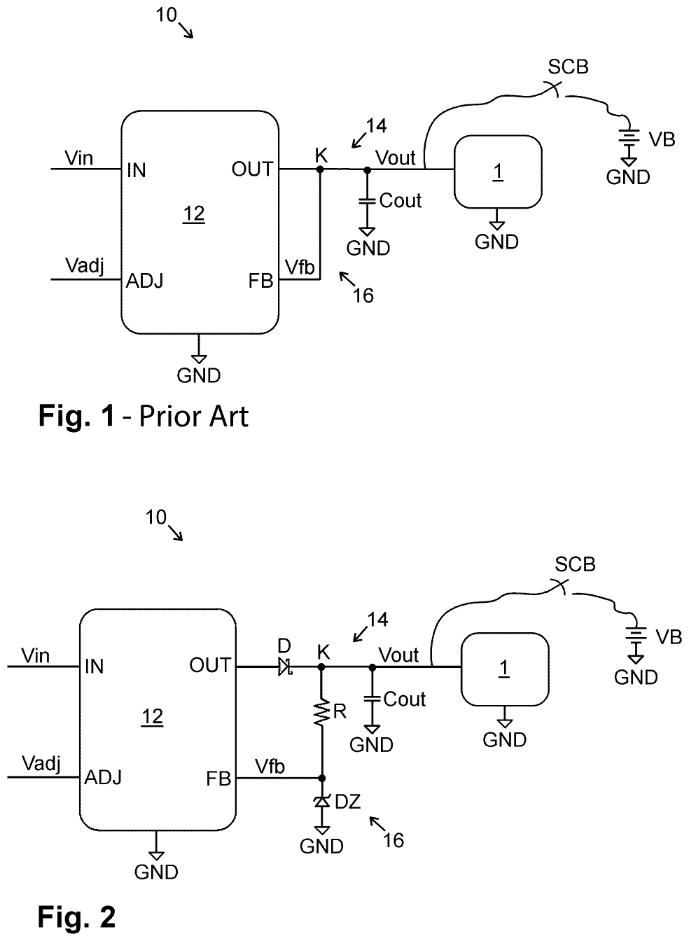

FIG. 1 shows a circuit arrangement 10 constructed according to a concept known from the prior art and used for supplying power to an electrical consumer 1 in a vehicle, which in operation requires a well-defined and stable supply voltage Vout, referred to a certain reference potential, in this case “ground potential GND”.

This is generally the case in vehicles, for example, for many control unit components such as microcontrollers and sensor devices (for example for measuring a pressure or a temperature). In the example of FIG. 1, it is assumed that the electrical consumer 1 is a sensor device of a vehicle to be supplied (at least up to a certain current of for example about 50 mA) with a precise and stable voltage of Vout=5 V (setpoint value).

The circuit arrangement 10 includes a voltage regulator component 12 having an input terminal IN for inputting an input voltage Vin, an output terminal OUT for outputting the output voltage Vout to the electrical consumer 1, and a feedback terminal FB for inputting a feedback voltage Vfb that is dependent on the output voltage Vout and that uses the voltage regulator component 12 as a variable for regulating the output voltage Vout. In the example of FIG. 1, it is assumed that the (unstabilized) input voltage Vin has a value of 6 V.

In the example illustrated, the input voltage Vin represents a supply voltage of the voltage regulator component 12 and can optionally also serve, for example, to supply other electronic components (not shown) that are provided, for example, in a manner structurally combined with the voltage regulator component 12 (for example in a control unit of the vehicle). In some examples, a control unit may be provided, for example, with a plurality of circuit arrangements of the type described herein, the corresponding plurality of voltage regulator components being supplied together from a supply voltage provided in the control unit (such as Vin in FIG. 1).

In the aforementioned regulating process, the feedback voltage Vfb is compared with a reference voltage Vadj and, based on the result of the comparison, the output voltage Vout is changed in such a way that the value of Vfb is matched to the value of Vadj. In the example illustrated, the voltage regulator component 12 has a setting terminal ADJ for inputting the reference voltage Vadj, with it being assumed in the example that Vadj has a value of 5 V.

The circuit arrangement 10 furthermore includes an output line 14 running from the output terminal OUT of the voltage regulator component 12 to the electrical consumer 1 and a feedback circuit 16 connected to a circuit node K of the output line 14 and to the feedback terminal FB of the voltage regulator component 12, by way of which output line the feedback voltage Vfb generated from the output voltage Vout tapped at the circuit node K is fed to the feedback terminal FB.

In the example illustrated, the feedback circuit 16 includes a low-impedance electrical connection between the circuit node K (branch) of the output line 14 and the feedback terminal FB. The output voltage Vout is thus used as a variable for regulating the output voltage Vout and is regulated to the reference voltage Vadj (thus in this case: Vout=Vadj=5 V).

In addition, in the example illustrated, an output capacitor Cout (between the output line and the ground potential GND) is arranged in the course of the output line 14 for additional stabilization (buffer storage) of the supply voltage Vout.

Voltage regulator components (for example automotive linear voltage controllers) that can be used in the usage situation illustrated in FIG. 1 are known from the prior art.

The output line 14 runs starting from the output terminal OUT of the voltage regulator component 12, which is installed in the example illustrated, for example, in an electronic control unit of the vehicle, over a length of several meters to the electrical consumer 1, specifically mostly in a cable harness, together with other electrical lines of the vehicle.

In this case, there is basically the risk that the voltage regulator component 12 is damaged or even destroyed by a short circuit, symbolized in FIG. 1 by a switch SCB, of the output line 14 with respect to a relatively high voltage, in the example illustrated a supply voltage VB (for example battery voltage of 24 V) of an electrical on-board power supply system of the vehicle.

Exemplary circuit arrangements according to the disclosure are described below with reference to FIGS. 2 to 4, in which the above problem is eliminated.

In this following description, the same reference signs are used for components that have the same effect. Essentially only the differences from the exemplary embodiment or embodiments already described will be discussed, and in other regards reference is explicitly made to the description of preceding exemplary embodiments.

FIG. 2 shows a first exemplary circuit arrangement 10. In contrast to the example described with reference to FIG. 1, a particular feature of the circuit arrangement 10 of FIG. 2 is that it includes, in a portion of the output line 14 between the output terminal OUT and the circuit node K, a semiconductor component, in this case in the form of a diode D (for example, Schottky diode) polarized in the forward direction for the current flowing for the supply of the electrical consumer 1 but, in the event of an excessively high voltage arising in the line portion between the diode D and the electrical consumer 1, comes to have a high impedance (since it is in the reverse direction), so that an excessive voltage increase at the output terminal OUT and thus damage to the voltage regulator component 12 is prevented.

Another feature of this example is that the feedback circuit 16 is formed by a resistor (current limiting resistor) R arranged between the circuit node K and the feedback terminal FB and a Zener diode DZ arranged between the feedback terminal FB and the ground potential GND, the breakdown voltage of which is greater than the setpoint value of the output voltage Vout. In this case, in normal operation, the feedback terminal FB is fed with the entire output voltage Vout and consequently the output voltage Vout is regulated to the reference voltage Vadj (for example to 5 V).

In the event of an excessively high voltage arising in the region of the output line 14, the Zener diode DZ advantageously relieves the load on both the diode D and the feedback input FB due to its breakdown. This also applies in an analogous manner if, for example, a suppressor diode or a varistor is used instead of the Zener diode DZ.

In some implementations of FIG. 2, the diode or Zener diode DZ is selected with a breakdown voltage in the range of from 1.5 to 3 times the setpoint value of the output voltage (in this case, for example, 5 V) and/or in the range of from 0.15 to 0.5 times the design maximum voltage.

The problem in this example is the voltage drop (typically about 0.5 V to 0.7 V) resulting at the diode D in normal operation of the circuit arrangement 10. For example, with a dropout voltage of the voltage regulator component 12 used of, for example, 0.5 V and an output voltage (setpoint value) Vout of 5 V, the use of the diode D with a voltage drop of, for example, 0.7 V requires an input voltage Vin of at least 6.2 V. However, if, for example, Vin=6 V is desired or required, the voltage regulation would not function reliably in this example.

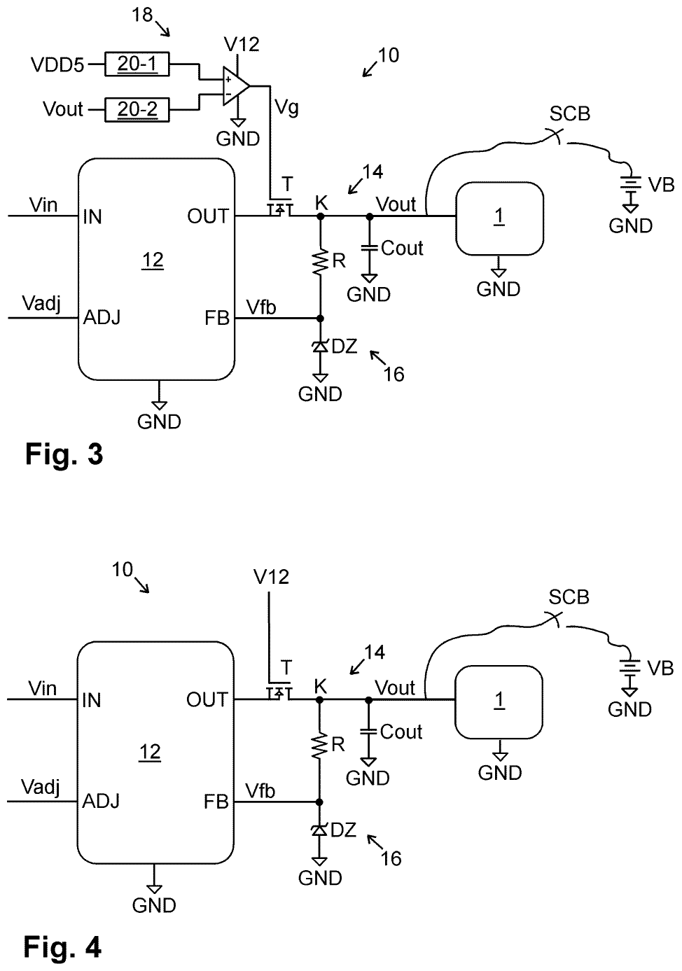

Exemplary embodiments are described below with reference to FIGS. 3 and 4, in which this above problem is eliminated and thus the range of use of the circuit arrangement is advantageously extended.

FIG. 3 shows a second exemplary circuit arrangement 10. In contrast to the example described with reference to FIG. 2, instead of the diode (FIG. 2) a transistor T is arranged in the portion of the output line 14 between the output terminal OUT and the circuit node K, which transistor in normal operation allows the current flowing for the supply of the electrical consumer 1 to pass through with a very low impedance (voltage drop for example less than 0.1 V), but, in the event of an excessively high voltage arising in the region of the output line 14, comes to have a high impedance (reverse direction), so that an excessive voltage increase at the output connection OUT and thus damage to the voltage regulator component 12 is prevented.

As shown, the transistor T is a FET, a switching voltage Vg for actively switching on and off the transistor T being applied to the gate terminal of the transistor. The switching voltage Vg is provided, as shown in FIG. 3, at the output of a comparator 18 that compares a voltage-divided version of the voltage Vout with an equally voltage-divided version of a, for example fixedly predefined, voltage, for example a supply voltage VDD5 provided in a control unit. Voltage dividers used here are designated in FIG. 3 by the reference numerals 20-1 and 20-2. In the example illustrated, the voltage VDD5 (for example 5 V) may simultaneously be, for example, the voltage fed to the voltage regulator component 12 as the reference voltage Vadj.

In the example of the circuit arrangement 10 of FIG. 3, the components 18, 20-1 and 20-2 thus form an actuation device in order to generate an actuation voltage Vg for the transistor T depending on the voltage Vout prevailing at the circuit node K, so that the transistor T is switched off and thus comes to have a high impedance when an excessively high voltage arises at the circuit node K.

The actuation device or the comparator 18 is supplied with another supply voltage, for example provided in the aforementioned control unit, V12, which in the example is greater than VDD5 and is, for example, 12 V.

The requirement or the costs of such an actuation device as well as the additional power consumption associated with it during operation of the circuit arrangement 10 in practice represent a disadvantage of this example.

FIG. 4 shows a third exemplary circuit arrangement 10, in which, unlike the example described with reference to FIG. 3, no such actuation device is provided. Instead, in the example of FIG. 4, a fixedly predefined voltage V12 is applied to the gate terminal (control terminal) of the transistor T, which voltage is selected such that the transistor T is brought into a reverse state and thus comes to have a high impedance when an excessively high voltage arises at the circuit node K.

In the example, the voltage V12 is a supply voltage for other electronic components (not shown) provided in an electronic control unit of the vehicle together with the voltage regulator component 12. The voltage V12 is therefore advantageously provided anyway in the region of an installation location of the voltage regulator component 12, in this case, for example, in an electronic control unit of the vehicle. For example, V12 is a voltage of 12 V.

As an alternative or in addition, the voltage V12 may also be, for example, a supply voltage provided on a line of a cable harness within the electrical system of the vehicle, with this cable harness also possibly being the one that is provided for routing the output line 14 (toward the consumer 1).

In some example, as shown in FIGS. 3 and 4, for example, an NMOSFET may advantageously be used as the transistor T, the source terminal of said NMOSFET being arranged on the side of the output terminal OUT and the drain connection thereof being arranged on the side of the output line 14 (as shown in FIGS. 3 and 4).

In this case, the operation of the circuit arrangement 10 in the example of FIG. 4 can be described under the premise that the voltage V12 applied to the gate terminal of the NMOSFET (for example 12 V) is greater than the setpoint value (for example 5 V) of the output voltage Vout, and the threshold voltage of the NMOSFET is smaller than the difference between the latter voltages (V12-Vout), described as follows:

In normal operation of the circuit arrangement 10, the gate-source voltage V12−Vout=7 V and is thus above the appropriately dimensioned threshold voltage (of for example 5 V) of the NMOSFET, the channel of which is thus conductive for the current flowing from the output connection OUT to the consumer 1. In this situation, the so-called inverse diode (parasitic diode) of the NMOSFET also additionally conducts in this current direction. The NMOSFET has a low impedance.

However, if an excessively high voltage of VB (or more) occurs in the line portion between the NMOSFET and the electrical consumer 1, for example triggered by a short circuit (closing the switch SCB), the NMOSFET switches to a reverse state since even after a relatively small increase in the voltage prevailing at the output connection OUT or source terminal, the gate-source voltage falls below the threshold voltage of the NMOSFET. In addition, the inverse diode then also blocks. The NMOSFET has a high impedance in this situation. This prevents an excessive voltage increase (for example by more than 2 V in this case) at the output connection OUT and thus prevents damage to the voltage regulator component 12.

In some examples with a transistor as the semiconductor component (see FIGS. 3 and 4), provision may advantageously be made within the scope of the disclosure for a leakage current of the transistor in reverse mode (for example switched off) to be smaller than the forward current in forward mode (for example switched on) by at least a factor of 100, such as at least a factor of 500.

In all of the implementations and examples of the disclosure, in the event of a fault (excessively high voltage at the output line), a necessary “high impedance” of the semiconductor component may make provision, for example, for a leakage current (in the event of a fault) to be at least a factor of 100 or, for example, a factor of 500 lower than the forward current (in normal operation) and/or for an electrical resistance of the element in the event of a fault to at least a factor of 100, in particular at least a factor of 500, greater than the resistance in normal operation.

In summary, advantageous circuit arrangements and their uses for voltage-regulated power supply of an electronic component in a vehicle are proposed by the present disclosure and the examples described above, where the electronic component may be, for example, a sensor device connected to the voltage regulator component in question via a cable harness of the vehicle. A particularly advantageous use of the disclosure results for an on-board power supply system voltage of the vehicle of more than 20 V (for example battery voltage of 24 V for a commercial vehicle, for example a truck).

A number of implementations have been described. Nevertheless, it will be understood that various modifications may be made without departing from the spirit and scope of the disclosure. Accordingly, other implementations are within the scope of the following claims.

### REFERENCE NUMERALS

1 Electrical consumer (for example sensor device)
10 Circuit arrangement
12 Voltage regulator component
IN Input terminal
Vin Input voltage
OUT Output terminal
Vout Output voltage
D Diode
T Transistor
ADJ Adjusting terminal
Vadj Reference voltage
FB Feedback terminal
VfB Feedback voltage
GND Ground potential
14 Output line
K Circuit node
Cout Output capacitor
16 Feedback circuit
R Resistor
DZ Zener diode
VB On-board power supply system voltage or battery voltage
SCB “Short-circuit” switch
18 Comparator
20-1, 20-2 Voltage divider
VDD5 Supply voltage
V12 Supply voltage

What is claimed is:

1. A circuit arrangement for supplying power to an electrical consumer in a vehicle, the circuit arrangement comprising:
a voltage regulator component comprising:
an input terminal for inputting an input voltage,
an output terminal for outputting an output voltage to the electrical consumer for supplying power to the electrical consumer, and
a feedback terminal for inputting a feedback voltage that is dependent on the output voltage and that uses the voltage regulator component as a control variable for regulating the output voltage;
an output line running from the output terminal to the electrical consumer; and
a feedback circuit connected to a circuit node of the output line and to the feedback terminal for generating the feedback voltage from the output voltage tapped at the circuit node and for feeding the generated feedback voltage to the feedback terminal,
wherein the circuit arrangement further comprises a semiconductor component arranged in a portion of the output line between the output terminal and the circuit node, the semiconductor component comes to have a high impedance in the event of an excessively high voltage arising in a portion of the output line between the semiconductor component and the electrical consumer in order to prevent an excessive voltage increase at the output terminal.

2. The circuit arrangement of claim 1, wherein the electrical consumer is a sensor device of a vehicle to be supplied with the output voltage.

3. The circuit arrangement of claim 1, wherein at least portions of the output line run in a cable harness of a vehicle.

4. The circuit arrangement of claim 1, wherein the electrical consumer is provided in a vehicle, and an electrical on-board power supply system of the vehicle has an on-board power supply system voltage of more than 12 V.5 .

5. The circuit arrangement of claim 1, wherein the output line has a length of more than 1 m.

6. The circuit arrangement of claim 5, wherein the length of the output line is more than 2 m.

7. The circuit arrangement of claim 1, wherein the feedback circuit comprises a current limiting resistor arranged between the circuit node and the feedback terminal and a Zener diode arranged between the feedback terminal and a ground potential.

8. The circuit arrangement of claim 1, wherein the semiconductor component is a transistor.

9. The circuit arrangement of claim 8, wherein the transistor is a FET.

10. The circuit arrangement of claim 8, wherein a fixedly predefined voltage is applied to a control terminal of the transistor.

11. The circuit arrangement of claim 10, wherein a supply voltage provided for the supply of the voltage regulator component and/or other electronic components is applied to the control terminal of the transistor.

12. A use of the circuit arrangement of claim 1 for supplying power to a sensor device in a vehicle.
